(19) United States
(12) Patent Application Publication
(10) Pub. No.: US 2006/0249578 A1
(43) Pub. Date: Nov. 9, 2006

(54) Method of confidential voting using personal voting codes

(76) Inventor: Fernando Morales, Reston, VA (US)

Correspondence Address: Fernando Morales, 2231 Wakerobin Lane, Reston, VA, 20191, US

(21) Appl. No.: 11/414,190

(22) Filed: May 1, 2006

Related U.S. Application Data
(60) Provisional application No. 60/678,550, filed on May 6, 2005.

(51) Int. Cl. G07C 13/00

(52) U.S. Cl. 235/386

(57) ABSTRACT

A method to prevent absentee voters from revealing their true choices by using personal voting codes (PVC) in casting their ballots, particularly absentee paper ballots. In one embodiment of the invention, voters write down sequential numbers to fill-out the available alternatives for each question on the ballot; for example, Mr. Bush, 3; Mr. Edwards, 4; Mr. Buchanan, 5 . . .” and so on. If bystanders are in the vicinity of the voter when the ballot is being completed, they would not be able to determine the voter's choice because they would be unable to discern the choice from the markings on the ballot; because of the use of personal voting codes, only the voter would know that the voter's candidate of choice is tagged with their PVC. In a particular example, the voter may have entered the number five (5) as a decision-making mark (a.k.a. PVC), which s/he later uses in the ballot to select the candidate of her/his choice (Mr. Buchanan in the example). After verifying, at the precinct from the information on return envelope, that the absentee/mail-in package unequivocally pertains to the identified voter, the election official would then open it to retrieve the sealed white envelope, which contains the secret ballot. The election official would then, write on white envelope area the PVC number as it appears on the computerized listing. The unopened white envelope, with the PVC written on it, would then be dropped into the ballot box.

### CROSS-REFERENCE TO RELATED APPLICATION

This application claims priority under 35 U.S.C. §119(e) of U.S. Provisional Patent Application Ser. No. 60/678,550, filed on May 6, 2005, the disclosure of which is hereby incorporated by reference thereto in its entirety..

### BACKGROUND OF THE INVENTION

1. Field of the Invention

The invention is directed to a method of confidential voting, particularly for voting using a manually completed ballot, while maintaining confidentiality, even in the presence of third parties while the ballot is completed.

More particularly, the invention is directed to a method of casting an absentee ballot.

2. Description of Background and Relevant Information

After more than a hundred years since the last revision of the Federal electoral law, the U.S. Congress passed The Help America Vote Act of 2002 (HAVA). The U.S. Election Assistance Commission (EAC) was established by HAVA. Central to its role, the Commission serves as a national clearinghouse and resource for information and review of procedures with respect to the administration of federal elections. According to the text of HAVA, the law was enacted to:
. . . establish a program to provide funds to states to replace punch card voting systems, to establish the Election Assistance Commission to assist in the administration of federal elections and to otherwise provide assistance with the administration of certain federal election laws and programs, to establish minimum election administration standards for states and units of local government with responsibility for the administration of federal elections, and for other purposes.
Excerpt from The Help America Vote Act of 2002

The Help America Vote Act of 2002 (HAVA) requires the Election Assistance Commission (EAC) among other things to generate technical guidance on the administration of federal elections and produce voluntary voting systems guidelines.

The Guidelines were developed by the HAVA-designated Technical Guidelines Development Committee (TGDC), comprised of technical experts, disability experts and election officials, and the National Institute of Standards and Technology (NIST).

The 2002 Help America Vote Act has given NIST a key role in helping to realize nationwide improvements in voting systems by January 2006. To assist the Election Assistance Commission with the development of voluntary voting system guidelines, HAVA established the TGDC and directs NIST to chair the TGDC. NIST research activities include:
security of computers, computer networks, and computer data storage used in voting systems;
methods to detect and prevent fraud;
protection of voter privacy; and
the role of human factors in the design and application of voting systems, including assistive technologies for individuals with disabilities (including blindness) and varying levels of literacy.

On May 9, 2005, the Technical Guidelines Development Committee (TGDC) delivered an initial set of recommendations for new voluntary voting system guidelines (known as the May 9, 2005 Voluntary Voting System Guidelines (WSG) Version 1, Initial Report) to the Election Assistance Commission (EAC). While the EAC was reviewing these recommendations and before they made a determination as to what they will put forward as the EAC's proposed voting system guidelines for public comment, on May 31, 2005, the inventor of the invention disclosed herein hand-delivered a letter to EAC General Counsel claiming that the VVSG Section 2.2.7.4.3 is non-compliant with HAVA requirements of privacy by the statement “There is no practical means to prevent a voter from revealing an absentee paper ballot to others” if a practical means does exist, precisely to prevent voters from revealing their true choices. This letter describes the practical means that are disclosed herein.

The EAC's proposed guidelines (without the non-compliant statement) were posted in the Federal Register and the EAC made the proposed guidelines document available for download from their website.

EAC accepted comments on the Guidelines for 90 days. Comments were posted on the website, submitted via email to votinqsvstemquidelines@eac.gov or mailed to: Voting System Guidelines Comments, U.S. Election Assistance Commission, 1225 New York Avenue, N.W., Suite 1100, Washington, DC 20005. The Guidelines were also available in hard copy and CD-ROM formats. Copies could be obtained by contacting EAC at 1-866-747-1471 or by visiting the EAC website at www.eac.gov.

At the conclusion of the public comment period and after the consideration of comments received, on Dec. 13, 2005, the EAC unanimously adopted the 2005 Voluntary Voting System Guidelines (VVSG 2005), which they claim then will significantly increase security requirements for voting systems and expand access, including opportunities to vote privately and independently, for individuals with disabilities. On Jan. 13, 2006, the EAC posted the VVSG 2005 without the non-compliant statement as follows:
The VVSG 2005 defines privacy as the ability to prevent others from determining how an individual voted. (Seepage A-14 of the VVSG 2005).
3.1.7 Privacy
The voting process shall preclude anyone else from determining the content of a voter's ballot, without the voter's cooperation.
Discussion: Privacy ensures that the voter can make selections based solely on his her own preferences without intimidation or inhibition. Among other practices, this forbids the issuance of a receipt to the voter that would provide proof on how he or she voted. (See page 51 of the VVSG 2005).
The guidelines will take effect in December 2007 (24 months), at which time voting systems will no longer be tested against the 2002 Voting System Standards (VSS) developed by the Federal Election Commission. All previous versions of national standards will become obsolete at that time.
The voluntary guidelines provide a set of specifications and requirements against which voting systems can be tested to determine if the systems provide all of the basic functionality, accessibility and security capabilities required of these systems. In addition, the guidelines establish evaluation criteria for the national certification of voting systems.
The guidelines update and augment the 2002 VSS, as required, by HAVA, to address advancements in election practices and computer technologies. These guidelines are voluntary. States may decide to adopt them entirely or in part prior to the effective date. Currently, at least 39 states use the national guidelines in their voting system certification process.

During the 90-day public comment period, EAC received more than 6,000 comments on the proposed guidelines. Each comment was reviewed and considered by EAC in consultation with the National Institute of Standards and Technology (NIST) in the development of the final version (VVSG 2005).

HAVA Section 301 Voting Systems Standards are a Federal mandate to all the States on and after Jan. 1, 2006. HAVA Section 301(c)(2) includes a dynamic mandate design to reach the state of the art, or level of excellence on protection of paper ballot voting systems.

For that reason at the time the EAC adopted the VVSG (Dec, 13, 2005) without the statement (“There is no practical means to prevent a voter from revealing an absentee paper ballot to others”) the privacy on paper ballot voting systems standards were raised to a new minimum, consistent with the invention disclosed and claimed herein.

The record shows as indisputable fact that the TGDC was unable to discover a solution to the lack of privacy on the absentee paper ballot voting systems. This fact clearly demonstrates that the solution described herein was not known nor obvious to experts, who were quite aware of U.S. Pat. No. 6,607,137 as early as the day they were appointed to serve on the TGDC by the EAC, and as the NIST record shows precisely from the inventor's communication to them, which can be found at the NIST website: www.vote.nist.gov/ECPosStat.htm

A review of numerous patents and published patent applications shows that only U.S. Pat. No. 6,607,137, the inventor of which is the inventor of the current subject matter, disclose how to achieve privacy when voting occurs with observers, but in no way explain how to achieve the same level of privacy protection using the paper ballot absentee process. Thus this innovative concept to use personal voting codes described in U.S. Pat. No. 6,607,137, using the invention described herein, can be used on paper ballot voting systems as well. The disclosure of U.S. Pat. No. 6,607,137 is hereby incorporated by reference thereto in its entirety and particularly with reference to the aforementioned personal voting codes.

Elections are the backbone of democracy, privacy ensures that the powerful cannot control the outcome of an election, which in many past cases was won by a few votes. There is a need for voting privacy to ensure that the voter can make selections based solely on his/her own preferences without intimidation, inhibition or economic incentives.

There is a need for a method that can allow the States and Elections Officials to reach for first time in history the desired level of voting privacy in or out of the polling places, raising the minimum standard for all future out-of-the-polling-place voting technologies and/or methodologies.

### SUMMARY OF THE INVENTION

The present invention satisfies the aforementioned needs by providing a method to prevent absentee voters from revealing their true choices by using personal voting codes (PVC) in their absentee paper ballots. Voters write down sequential numbers to fill-out the available alternatives for each question on the ballot; for example, Mr. Bush, 3; Mr. Edwards, 4; Mr. Buchanan, 5 ...” and so on. If bystanders are in the vicinity of the voter, they would not know who s/he voted for, only the voter would. Nobody but the voter would know that the candidate of their choice is tagged with their PVC. In the example described herein, the voter may have entered on the computerized list (as defined by HAVA) the number five (5) as a decision-making mark (a.k.a. PVC), which s/he later uses in the ballot to select the candidate of her/his choice (Mr. Buchanan in the example). The PVC must be secret and handled accordingly. The PVC should preferably be created by the voter, but it can be initially set as one digit of the information contained on the computerized list (likely to be known only by the voter).

After verifying, at the precinct from the information on the envelope containing the absentee ballot, that the absentee/mail-in package unequivocally pertains to the identified voter, the election official then opens it to retrieve the sealed envelope, which contains the secret ballot. The election official then writes on the envelope in a particular designated area the PVC number as it appears on the computerized listing. The unopened envelope, with the PVC written on it, is then dropped into the ballot box. The envelope containing the ballot could be lined with carbon-paper so that the election official (EO) can write the PVC on the ballot as well by simply writing the PVC on the outside of the envelope. Similarly an envelope with a perforation can allow the EO to write the PVC directly on the ballot.

It is an object of the invention therefore to provide a method to vote with privacy in absentee voting.

It is an object of the invention therefore to provide a method to vote with privacy in early voting.

It is an object of the invention therefore to provide a method to vote with privacy in voting by mail.

It is an object of the invention therefore to provide a method to vote with privacy without a booth.

It is an object of the invention therefore to provide a method to vote with privacy for people with vision disabilities.

It is an object of the invention therefore to provide a method to vote with privacy for people with motion disabilities.

It is an object of the invention therefore to provide the convenience to vote wherever they want, to all voters that are required by State law to vote at the polling place because was the only way to prevent vote treading, coercion or intimidation.

These and other advantages of the invention will become more fully apparent when the following detailed description of the invention is read in conjunction with the accompanying drawings.

### BRIEF DESCRIPTION OF THE DRAWINGS

Other aspects of the invention will be set forth in the following detailed description, which refers to the appended drawings in which:

FIG. 1 is a schematic illustration of a cast ballot system of the invention;

FIG. 2 is a diagram of various parts of a voting package according to the invention; and

FIG. 3 is a diagram of a ballot-protecting envelope according to the invention.

### DETAILED DESCRIPTION OF THE INVENTION

The invention is directed to a method for ensuring privacy for a paper ballot voting system, or a system using non-electronic ballots, although such ballots could be machine-readable. The invention is also directed to the system itself. By means of the invention, the voter can make selections based solely on his her own preferences without intimidation, inhibition or economic incentive. Furthermore, the system prevents election officials and observers of the electoral tally from determining how any individual voted.

Turning now to the drawing figures, the overall configuration of the invention and its components are described below.

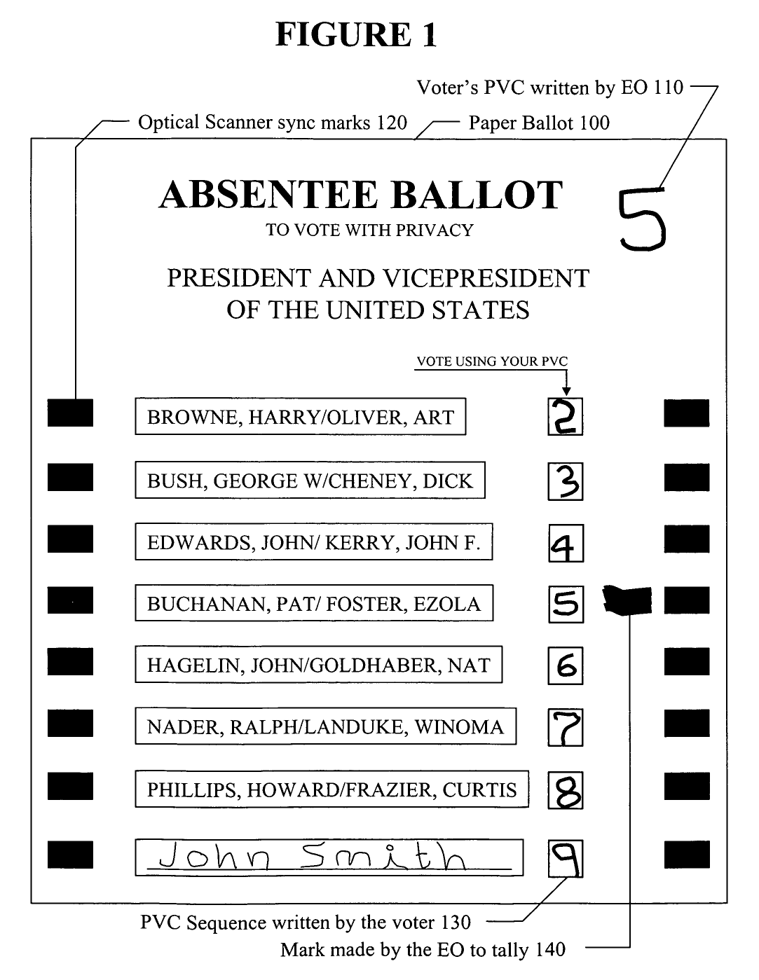

FIG. 1 essentially shows a cast paper ballot 100 with a personal voting code sequence 130 which the voter could use to write his/her PVC in the designated area on the ballot to communicate the intended alternative (such as a candidate or ballot question or other alternative) indicated on the ballot. Also shown is the voter's PVC 110 written by the election official (EO) after determination by the EO in the record of the voter on the electoral list. The ballot 100 also contains marks 120 that can be utilized by an optical scanner to synchronize the areas to tally, after detecting the mark 140 made by the EO in the correct position, after removing the ballot 100 from the white envelope 230 and after reading the voter's PVC 110 and finding the correct match.

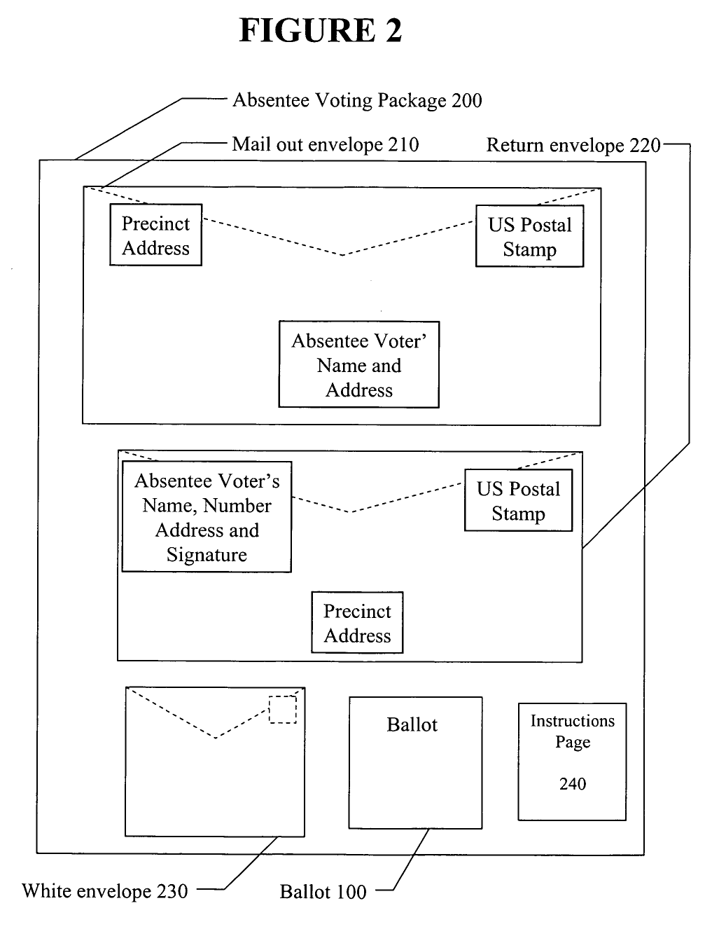

In a particular embodiment of the invention, the voting package 200 shown in FIG. 2 includes three envelopes 210, 220 and 230 of three different sizes, in order to fit all of them in the envelope 210 as well as to fit the ballot 100 and the voting instructions 240.

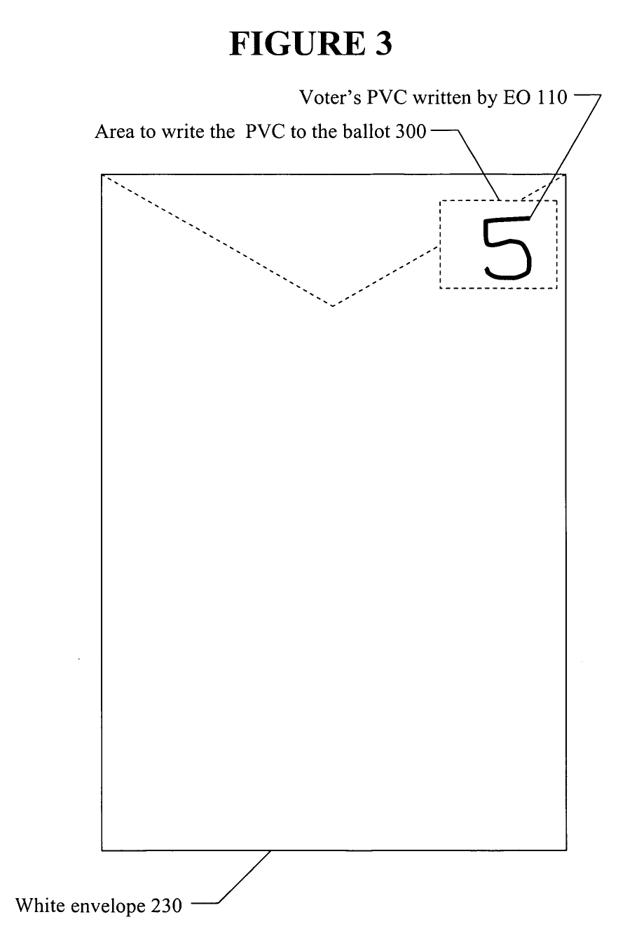

FIG. 3 depicts an example of the smaller envelope or white envelope 230, which has an area 300 to write the PVC to the ballot 100. That area 300 may have an internal carbon-paper bond so that the Election Official (EO) can write the PVC on the ballot as well by simply writing the PVC on the outside of the envelope 230. Alternatively, the area 300 can be merely a perforation window on the envelope 230 to achieve the same result.

Those skilled in the art of the present invention will recognize that other embodiments using the concepts described herein are also possible, to protect the secrecy of the ballot in front of the EOs such as partial envelope or an stick removable material, such alternatives and equivalents being encompassed within the claimed invention.

1. A voting method using a voter's personal voting code enabled ballot for confidential identification of one or more ballot choices on said ballot, said method comprising:
using the voter's personal voting code to communicate one or more choices of the voter on a non-electronic ballot.

2. A voting method according to claim 1, further comprising:
placing the non-electronic ballot, after the voter has indicated one or more voter choices with the voter's personal voting code, into a ballot cover to maintain secrecy of the ballot.

3. A voting method according to claim 2, wherein the ballot cover comprises an envelope, the method further comprising:
determining, by an election official or designated precinct worker, the voter's personal voting code maintained in an electoral list;
marking, by the election official or designated precinct worker, the voter's personal voting code on the outside of the envelope, containing the non-electronic ballot.

4. A voting method according to claim 2, wherein the ballot cover comprises an envelope including means to allow marking the ballot while the ballot is contained within the envelope, the method further comprising:
determining, by an election official or designated precinct worker, the voter's personal voting code maintained in an electoral list;
marking, by the election official or designated precinct worker, the voter's personal voting code on the ballot while the ballot is contained within the envelope.

5. A voting method according to claim 4, wherein:
said means to allow marking the ballot while the ballot is contained within the envelope comprises a perforated window in the envelope.

6. A voting method according to claim 4, wherein:
said means to allow marking the ballot while the ballot is contained within the envelope comprises a carbon-paper lining of the envelope.

7. A voting method according to claim 4, wherein:
said means to allow marking the ballot while the ballot is contained within the envelope comprises transportable ink.

8. A voting method according to claim 1, wherein the voting code enabled ballot includes a plurality of alternative areas for placing a mark by the voter, the method further comprising:
marking one of the alternative areas with the voter's personal voting code; and
marking one or more additional ones of said plurality of alternative areas with marks different from the voter's personal voting code.

9. A voting method according to claim 8, wherein:
said marks different from the voter's personal voting code comprise a sequentially numbered or lettered markings, or random markings.

10. A voting method according to claim 2, the method further comprising:
determining, by an election official or designated precinct worker, the voter's personal voting code maintained in an electoral list;
marking, by the election official or designated precinct worker, the voter's personal voting code on the ballot while the ballot is contained within the ballot cover;
tallying the one or more choices of the voter as indicated on the non-electronic ballot.

11. A voting method according to claim 10, wherein the non-electronic ballot contains optical scanner-readable marks respectively indicative of a plurality of alternative ballot choices, wherein:
the tallying of the one or more choices of the voter is done with an optical scanner.

12. A voting method according to claim 10, wherein:
the tallying of the one or more choices of the voter is done manually.
